(19) United States
(12) Patent Application Publication
(10) Pub. No.: US 2026/0163981 A1
(43) Pub. Date: Jun. 11, 2026

(54) SYSTEMS AND METHODS FOR PROVIDING IN-CALL PRIVACY ALERT MESSAGES

(71) Applicant: Verizon Patent and Licensing Inc., Basking Ridge, NJ (US)

(72) Inventors: Nanjun QIAN, Princeton, NJ (US); Jun YUAN, Cranbury, NJ (US); Rakesh PATEL, East Windsor, NJ (US); Anil Kumar KHITOLIA, Flanders, NJ (US)

(73) Assignee: Verizon Patent and Licensing Inc., Basking Ridge, NJ (US)

(21) Appl. No.: 18/972,019

(22) Filed: Dec. 6, 2024

(51) Int. Cl. H04M 15/00; H04M 1/72469

(52) U.S. Cl. CPC H04M 15/842; H04M 1/72469

(57) ABSTRACT

A first user equipment (UE) may detect a connection to a wireless communication system or an activation of a speakerphone function, and may trigger a privacy announcement option based on the detection of the connection to the wireless communication system or the activation of the speakerphone function. The first UE may receive a selection of the privacy announcement option, and may generate a privacy announcement alert based on the selection of the privacy announcement option. The first UE may provide the privacy announcement alert to a second UE to cause the second UE to provide the privacy announcement alert to a user of the second UE.

### BACKGROUND

Call privacy has become increasingly nuanced with the proliferation of mobile devices (e.g., user equipments (UEs)) and the use of hands-free audio systems, such as Bluetooth-connected vehicles and speakerphones. These technological advances have improved convenience and safety, allowing users of UEs to remain connected while on the move.

### BRIEF DESCRIPTION OF THE DRAWINGS

FIGS. 1A-1F are diagrams of an example associated with providing in-call privacy alert messages.

FIG. 2 is a diagram of an example environment in which systems and/or methods described herein may be implemented.

FIG. 3 is a diagram of example components of one or more devices of FIG. 2.

FIG. 4 is a flowchart of an example process for providing in-call privacy alert messages.

### DETAILED DESCRIPTION OF EXAMPLE EMBODIMENTS

The following detailed description of example implementations refers to the accompanying drawings. The same reference numbers in different drawings may identify the same or similar elements.

Hands-free audio systems present challenges regarding conversational privacy, especially when a call participant is unaware that their conversation is being broadcast over speakers within earshot of others. In the context of mobile phone calls, the speakerphone

function and Bluetooth car kits are widely used for hands-free communication. However, these technologies expose a significant gap in the assurance of privacy for individuals involved in a call. When a user is engaged in a conversation through a car speaker system or on a speakerphone, there may be unintended audiences, such as family members, passengers, or even bystanders, who can overhear the conversation. The problem is compounded when considering that the transition to hands-free audio is often fluid, with users frequently moving in and out of such scenarios without a clear mechanism to indicate these changes to the other party on the call.

Thus, current techniques for providing calls consume computing resources (e.g., processing resources, memory resources, communication resources, and/or the like), networking resources, and/or other resources associated with failing to provide an effective means for a user to communicate a status of a call audio output to another party involved in the call, inadvertently sharing sensitive or private information via call audio output, handling privacy breaches caused by inadvertently sharing sensitive or private information via call audio output, and/or the like.

Some implementations described herein relate to a UE that provides in-call privacy alert messages. For example, a first UE may detect a connection to a Bluetooth system or an activation of a speakerphone function, and may trigger a privacy announcement option based on the detection of the connection to the Bluetooth system or the activation of the speakerphone function. The first UE may receive a selection of the privacy announcement option, and may generate a privacy announcement alert intended for a recipient UE (e.g., a second UE), based on the selection of the privacy announcement option. The first UE may provide the privacy announcement alert to the second UE to cause the second UE to provide the privacy announcement alert to a user of the second UE.

In this way, a UE may provide in-call privacy alert messages. For example, a first UE may utilize existing telecommunications protocols to relay privacy notifications to a second UE, thereby minimizing a likelihood of sensitive information disclosure by the originating caller and/or the terminating caller. The first UE may embed privacy flags directly into call setup signaling messages, which may enhance technical interoperability between different devices. The first UE may provide a security alert for a call with the second UE by preemptively managing privacy considerations through automated means. The first UE may ensure resource-efficient management of privacy-related features by building upon existing communication capabilities of the first UE, resulting in enhanced operational efficiency and optimized utilization of processing and memory resources of the first UE. Thus, the first UE may conserve computing resources, networking resources, and/or other resources that would have otherwise been consumed by failing to provide an effective means for a user to communicate a status of a call audio output to another party involved in the call, inadvertently sharing sensitive or private information via call audio output, handling privacy breaches caused by inadvertently sharing sensitive or private information via call audio output, and/or the like.

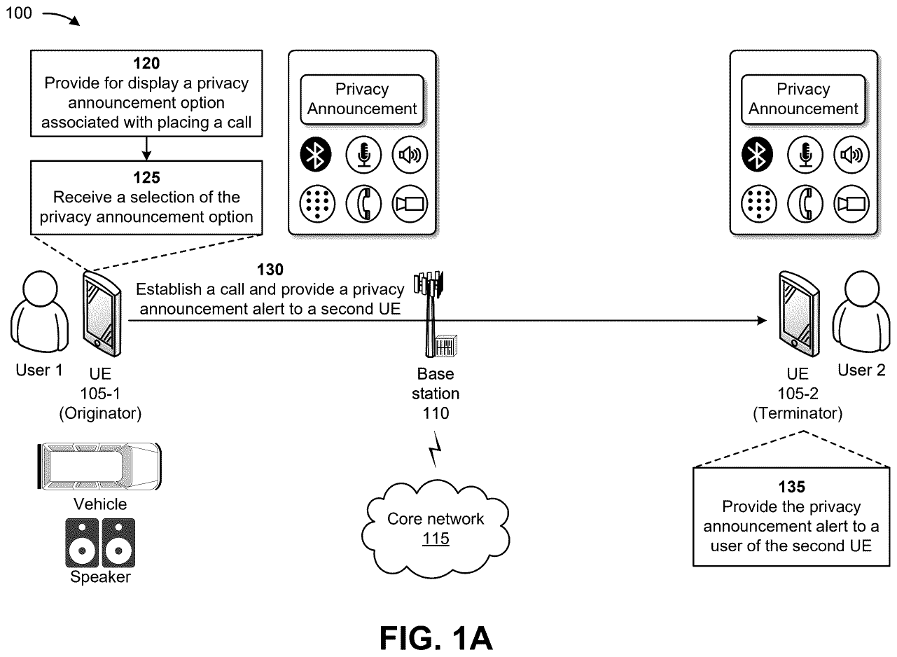

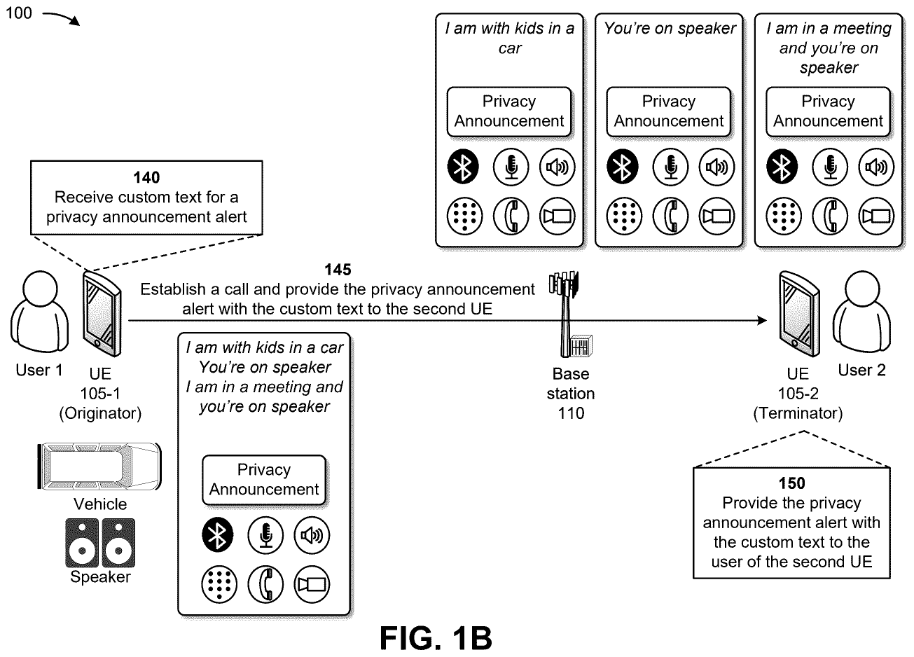

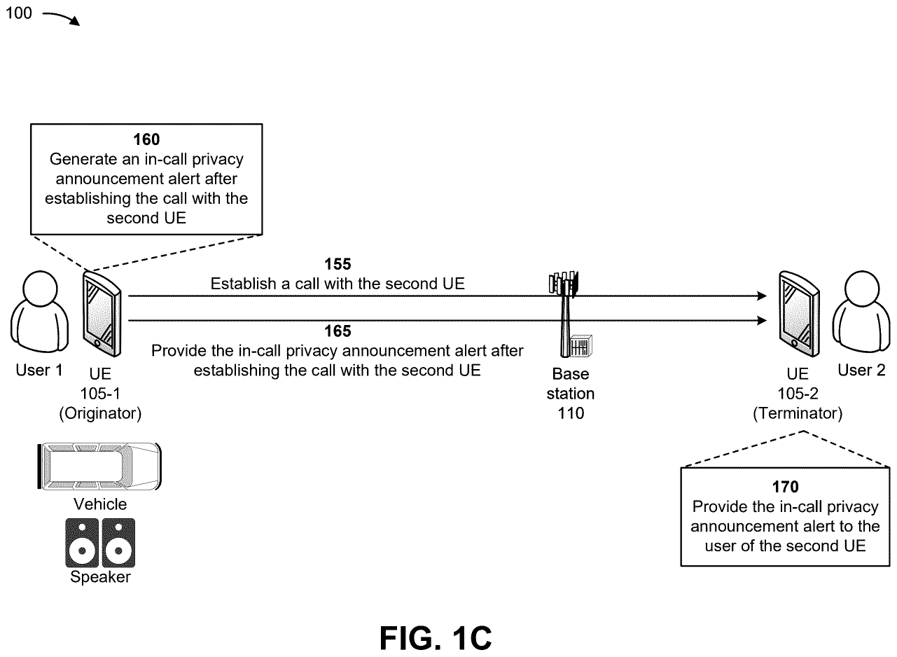

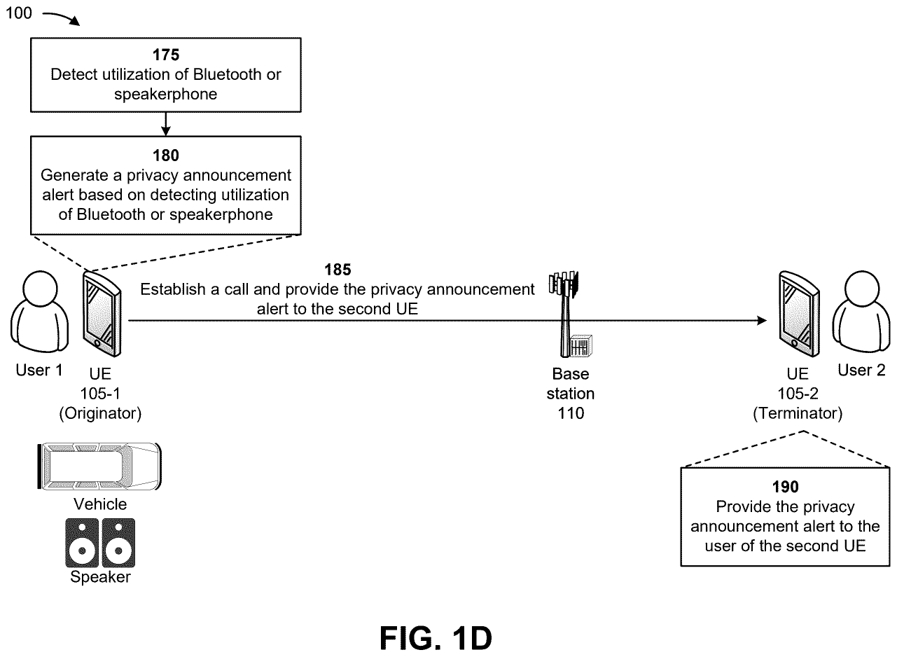

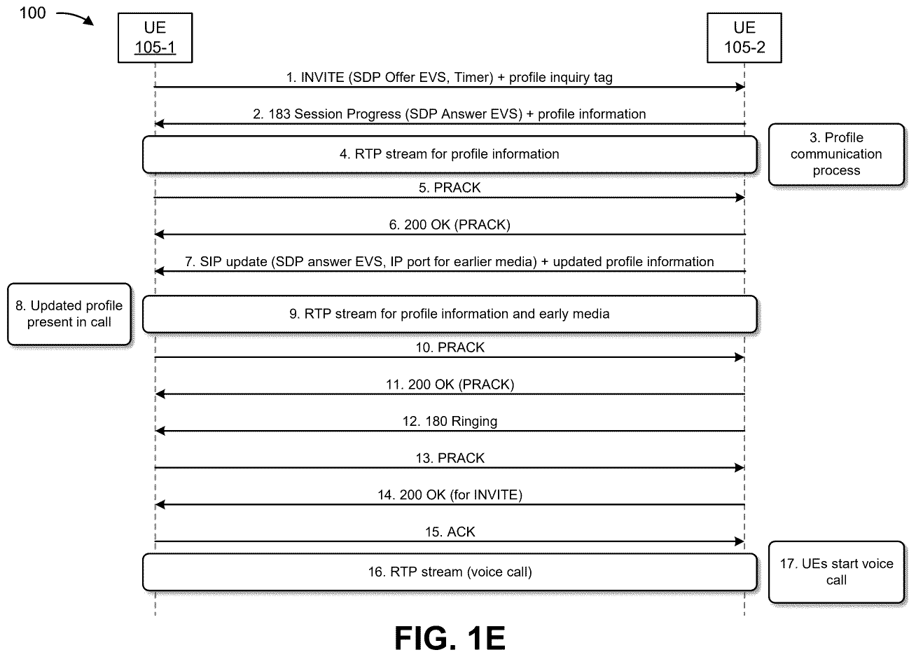

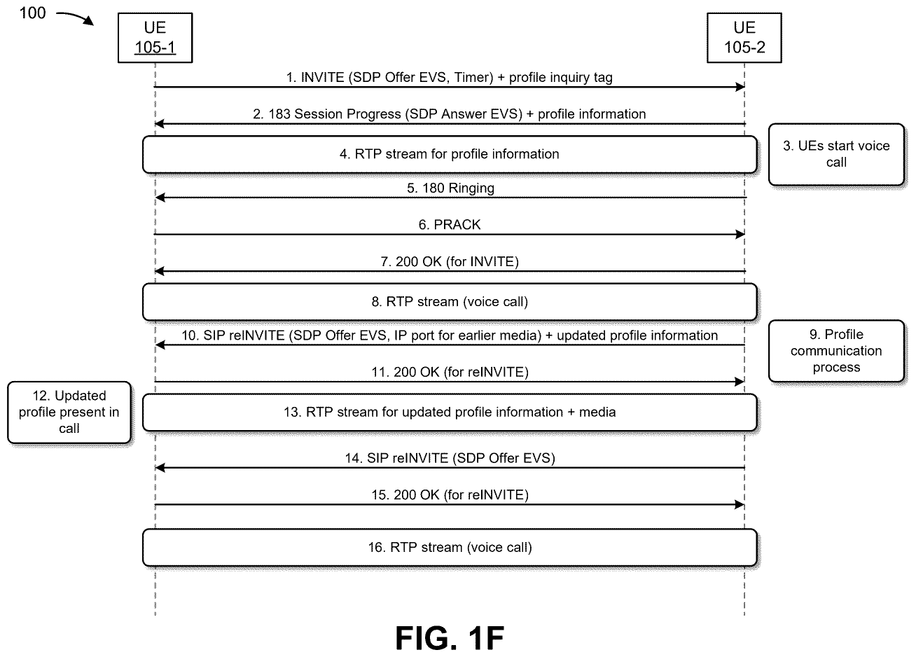

FIGS. 1A-1F are diagrams of an example 100 associated with providing in-call privacy alert messages. As shown in FIGS. 1A-1F, example 100 includes a first UE 105-1 and a second UE 105-2 associated with a base station 110 and a core network 115. The first UE 105-1 may be associated with a first user (e.g., user 1) and the second UE 105-2 may be associated with a second user (e.g., user 2). As further shown, the first UE-1 may be an originator of a call and may be associated with a Bluetooth system provided in a vehicle and capable of communicating with the first UE 105-1 (e.g., by providing audio from a call associated with the first UE 105-1). Alternatively, or additionally, the first UE 105-1 may be associated with a speakerphone function provided by an operating system of the first UE 105-1 or by a speaker capable of communicating

with the first UE 105-1 (e.g., by providing audio from a call associated with the first UE 105-1). The second UE 105-2 may be a terminator of a call originated by the first UE 105-1. Further details of the UEs 105, the base station 110, and the core network 115 are provided elsewhere herein. In some implementations, the second UE 105-2 may perform the functions described herein as being performed by the first UE 105-1, and the first UE 105-1 may perform the functions described herein as being performed by the second UE 105-2. For example, the second UE-2 may be associated with a Bluetooth system provided in a vehicle and capable of communicating with the second UE 105-2, may be associated with a speakerphone function provided by an operating system of the second UE 105-2 or by a speaker capable of communicating with the second UE 105-2. In some implementations, the first UE 105-1 and/or the second UE 105-2 may utilize communication technologies other than a Bluetooth system or a speakerphone function when generating or receiving calls.

As shown by FIG. 1A, and by reference number 120, the first UE 105-1 may provide for display a privacy announcement option associated with placing a call. For example, the first UE 105-1 may provide the privacy announcement option as an element of a call setup user interface. The call setup user interface may include elements (e.g., icons) that, when selected, may establish a Bluetooth connection (e.g., via a Bluetooth system of the vehicle), may enable the first user to utilize a microphone of the first UE 105-1, may enable a speakerphone function to be utilized, may provide a keypad for entering a phone number, may place a call to a phone number, may enable the first user to utilize a camera of the first UE 105-1, and/or the like. The privacy announcement option, when selected, may allow the first user to select privacy-related options before initiating the call. In some implementations, the first UE 105-1 may automatically enable the privacy announcement option based on predefined settings. For

example, settings stored in the first UE 105-1 may dictate that whenever a Bluetooth connection or a speakerphone activation is detected, the privacy announcement option is to be automatically triggered without user intervention. In some implementations, the first user and/or the second user may opt-in or opt-out of the privacy announcement option associated with placing a call.

As further shown in FIG. 1A, and by reference number 125, the first UE 105-1 may receive a selection of the privacy announcement option. For example, after displaying the privacy announcement option, the first UE 105-1 may detect a first user input selecting the privacy announcement option, which may indicate the first user's preference for notifying the call recipient about the privacy status of the call. In some implementations, the first UE 105-1 may generate a privacy announcement alert based on receiving the selection of the privacy announcement option. Additionally, or alternatively, after receiving the selection of the privacy announcement option, the first UE 105-1 may display one or more predefined message options for the privacy announcement alert. Additionally, or alternatively, the first UE 105-1 may enable custom messages to be entered by the first user. Additionally, or alternatively, receiving the selection of the privacy announcement option may include the first UE providing a touchscreen user interface element associated with the privacy announcement option, and detecting a touch input of the touchscreen user interface element. The first UE 105-1 may receive the selection of the privacy announcement option based on detecting the touch input of the touchscreen user interface element.

As further shown in FIG. 1A, and by reference number 130, the first UE 105-1 may establish a call with the second UE 105-2 and may provide a privacy announcement alert to the second UE 105-2. For example, the first UE 105-1 may utilize a telecommunications protocol to initiate a call through the base station 110 and the core network 115 and directed to the second

UE 105-2. In some implementations, the first UE 105-1 may embed the privacy announcement alert in the call setup signaling provided to the second UE 105-2. In some implementations, the first UE 105-1 may generate the privacy announcement alert based on receiving the selection of the privacy announcement option. The privacy announcement alert may include information indicating, to the second user of the second UE 105-2, the privacy conditions under which the call is being made. In some implementations, the privacy announcement alert may include an audible alert (e.g., a beep), a visual alert (e.g., a message, a graphic, an emoji, and/or the like), and/or a tactile alert (e.g., vibration).

Additionally, or alternatively, establishing the call and providing the privacy announcement alert may include the first UE 105-1 embedding a privacy flag within a signaling message in the call setup phase between the first UE 105-1 and the second UE 105-2. For example, the first UE 105-1 may insert a specific code or flag within the initial call setup message that instructs the second UE 105-2 to recognize and handle the privacy announcement alert appropriately. Additionally, or alternatively, establishing the call and providing the privacy announcement alert may include the first UE 105-1 establishing the call with the second UE 105-2 while simultaneously providing the privacy announcement alert to the second UE 105-2. For example, the first UE 105-1 may provide the privacy announcement alert to the second UE 105-2 either through an immediate message or as part of the ongoing call setup, ensuring that the privacy announcement alert is recognized as the call is being established.

As further shown in FIG. 1A, and by reference number 135, the second UE 105-2 may provide the privacy announcement alert to the second user of the second UE 105-2. For example, upon receiving the privacy announcement alert from the first UE 105-1, the second UE 105-2 may display the privacy announcement alert to the second user as a visual notification or

may play the privacy announcement alert as an audible alert, informing the second user of the second UE 105-2 of the privacy status of the first UE 105-1. In some implementations, the second UE 105-2 may provide the privacy announcement alert to the second user as a visual alert (e.g., a pop-up message on a screen of the second UE 105-2), an audible alert, an audible and visual alert, a tactile alert (e.g., a distinct vibration pattern), or a combination of these types of alerts to ensure that the second user is clearly informed of the privacy announcement alert.

As shown by FIG. 1B, and by reference number 140, the first UE 105-1 may receive custom text for a privacy announcement alert. For example, the first UE 105-1 may display a user interface that enables the first user to input custom text messages for the privacy announcement alert. The custom text input may include options, such as “I am with kids in a car,” “You're on speaker,” or “I am in a meeting and you're on speaker,” to clearly indicate a privacy context to the call recipient (e.g., the second user). In some implementations, the first UE 105-1 may request and receive the custom text for the privacy announcement alert based on receiving the selection of the privacy announcement option, as described above in connection with FIG. 1A. Additionally, or alternatively, the first UE 105-1 may request and receive the custom text for the privacy announcement alert based on detecting a connection to a Bluetooth system (e.g., provided in the vehicle). Additionally, or alternatively, the first UE 105-1 may request and receive the custom text for the privacy announcement alert based on detecting the activation of a speakerphone function.

As further shown in FIG. 1B, and by reference number 145, the first UE 105-1 may establish a call with the second UE 105-2 and may provide the privacy announcement alert with the custom text to the second UE 105-2. For example, once the custom text for the privacy announcement alert is received, the first UE 105-1 may utilize a telecommunications protocol to

initiate a call through the base station 110 and the core network 115 and directed to the second UE 105-2. In some implementations, the first UE 105-1 may embed the privacy announcement alert with the custom text in the call setup signaling provided to the second UE 105-2. The privacy announcement alert with the custom text may include information indicating, to the second user of the second UE 105-2, the privacy conditions under which the call is being made.

Additionally, or alternatively, establishing the call and providing the privacy announcement alert with the custom text may include the first UE 105-1 embedding a privacy flag and the custom text within a signaling message in the call setup phase between the first UE 105-1 and the second UE 105-2. For example, the first UE 105-1 may insert a specific code or flag and the custom text within the initial call setup message that instructs the second UE 105-2 to recognize and handle the privacy announcement alert with the custom text appropriately. Additionally, or alternatively, establishing the call and providing the privacy announcement alert with the custom text may include the first UE 105-1 establishing the call with the second UE 105-2 while simultaneously providing the privacy announcement alert with the custom text to the second UE 105-2. For example, the first UE 105-1 may provide the privacy announcement alert with the custom text to the second UE 105-2 either through an immediate message or as part of the ongoing call setup, ensuring that the privacy announcement alert with the custom text is recognized as the call is being established.

As further shown in FIG. 1B, and by reference number 150, the second UE 105-2 may provide the privacy announcement alert with the custom text to the second user of the second UE 105-2. For example, upon receiving the privacy announcement alert with the custom text from the first UE 105-1, the second UE 105-2 may display the privacy announcement alert with the custom text to the second user as a visual notification or may play the privacy announcement

alert with the custom text as an audible alert, informing the second user of the second UE 105-2 of the privacy status of the first UE 105-1. In some implementations, the second UE 105-2 may provide the privacy announcement alert with the custom text to the second user as a visual alert (e.g., a pop-up message on a screen of the second UE 105-2), an audible alert, an audible and visual alert, a tactile alert (e.g., a distinct vibration pattern), or a combination of these types of alerts to ensure the second user is clearly informed of the privacy announcement alert with the custom text.

As shown by FIG. 1C, and by reference number 155, the first UE 105-1 may establish a call with the second UE 105-2. For example, the first UE 105-1 may utilize a telecommunications protocol to initiate and establish a call through the base station 110 and the core network, directed to the second UE 105-2. In some implementations, the first UE 105-1 may establish the call with the second UE 105-2 prior to generating and providing a privacy announcement alert to the second UE 105-2.

As further shown in FIG. 1C, and by reference number 160, the first UE 105-1 may generate an in-call privacy announcement alert after establishing the call with the second UE 105-2. For example, upon establishing the call with the second UE 105-2, the first UE 105-1 may automatically generate the in-call privacy announcement alert to inform the second user of the privacy conditions under which the call is being conducted. In some implementations, upon establishing the call with the second UE 105-2, the first UE 105-1 may automatically provide for displaying the privacy announcement option associated with the ongoing call. For example, the first UE 105-1 may provide the privacy announcement option as an element of an ongoing call user interface. The privacy announcement option, when selected, may allow the first user to select privacy-related options for the ongoing call.

In some implementations, the first UE 105-1 may automatically enable the privacy announcement option based on predefined settings. For example, settings stored in the first UE 105-1 may dictate that whenever a Bluetooth connection or a speakerphone activation is detected, the privacy announcement option is to be automatically triggered without user intervention. In some implementations, after displaying the privacy announcement option, the first UE 105-1 may detect a first user input selecting the privacy announcement option, which may indicate the first user's preference for notifying the call recipient about the privacy status of the call. In some implementations, the first UE 105-1 may generate the in-call privacy announcement alert based on receiving the selection of the privacy announcement option.

As further shown in FIG. 1C, and by reference number 165, the first UE 105-1 may provide the in-call privacy announcement alert to the second UE 105-2 after establishing the call with the second UE 105-2. For example, the first UE 105-1 may send the in-call privacy announcement alert via the established call signaling or as a separate, concurrent communication to ensure that the second UE 105-2 receives and handles the alert appropriately. In some implementations, the first UE 105-1 may embed the in-call privacy announcement alert in the established call signaling provided to the second UE 105-2. The in-call privacy announcement alert may include information indicating, to the second user of the second UE 105-2, the privacy conditions to be utilized for the ongoing call. Additionally, or alternatively, providing the in-call privacy announcement alert may include the first UE 105-1 embedding a privacy flag within a signaling message of the ongoing call between the first UE 105-1 and the second UE 105-2. For example, the first UE 105-1 may insert a specific code or flag within a call message that instructs the second UE 105-2 to recognize and handle the in-call privacy announcement alert appropriately.

As further shown in FIG. 1C, and by reference number 170, the second UE 105-2 may provide the in-call privacy announcement alert to the second user of the second UE 105-2. For example, upon receiving the in-call privacy announcement alert from the first UE 105-1, the second UE 105-2 may display the in-call privacy announcement alert to the second user as a visual notification or may play the in-call privacy announcement alert as an audible alert, informing the second user of the second UE 105-2 of the privacy status of the first UE 105-1. In some implementations, the second UE 105-2 may provide the in-call privacy announcement alert to the second user as a visual alert (e.g., a pop-up message on a screen of the second UE 105-2), an audible alert, an audible and visual alert, a tactile alert (e.g., a distinct vibration pattern), or a combination of these types of alerts to ensure that the second user is clearly informed of the in-call privacy announcement alert.

As shown by FIG. 1D, and by reference number 175, the first UE 105-1 may detect utilization of Bluetooth or a speakerphone. For example, the first UE 105-1 may determine that the first UE 105-1 is paired with a Bluetooth system (e.g., associated with the vehicle) or may determine an activation status of the speakerphone function (e.g., via monitoring an operating system of the first UE 105-1). In some implementations, the first UE 105-1 may identify a specific Bluetooth profile associated with the vehicle and may confirm successful pairing with the Bluetooth profile. Additionally, or alternatively, the first UE 105-1 may continually monitor status indicators of the operating system to determine when the speakerphone function has been activated.

In cases where the Bluetooth connection is lost during an ongoing call, the first UE 105-1 may deactivate the privacy announcement alert and may notify the second UE 105-2 of the change. Similarly, if the speakerphone function is deactivated mid-call, the first UE 105-1 may

cease sending the privacy announcement alert and may trigger an update to the ongoing call status, ensuring that the second user is informed of the change. This handling of dynamic changes ensures that privacy alerts remain accurate throughout the call.

In some implementations, the first UE 105-1 may automatically detect the audio connection of the first UE 105-1, such as by determining whether audio of the first UE 105-1 is routed through a speakerphone or a Bluetooth car kit, before a call is accepted or during an ongoing call. This detection can be facilitated by a flag transmitted through an Internet protocol multimedia subsystem (IMS), which triggers the privacy announcement option based on the detected audio connection. For instance, when the speakerphone function or Bluetooth car connection is activated, a predefined flag in the IMS can prompt the first UE 105-1 to automatically enable the privacy announcement feature, ensuring that the privacy status is communicated efficiently without manual intervention.

As further shown in FIG. 1D, and by reference number 180, the first UE 105-1 may generate a privacy announcement alert based on detecting the utilization of Bluetooth or the speakerphone. For example, upon detecting the Bluetooth connection or the speakerphone activation, the first UE 105-1 may create the privacy announcement alert to notify the call recipient (e.g., the second user) of the privacy status. In some implementations, upon detecting the Bluetooth connection or the speakerphone activation, the first UE 105-1 may automatically provide for displaying the privacy announcement option. For example, the first UE 105-1 may provide the privacy announcement option as an element of a call setup user interface. The privacy announcement option, when selected, may allow the first user to select privacy-related options for a call to be established.

In some implementations, the first UE 105-1 may automatically enable the privacy

announcement option based on predefined settings. For example, settings stored in the first UE 105-1 may dictate that whenever a Bluetooth connection or a speakerphone activation is detected, the privacy announcement option is to be automatically triggered without user intervention. In some implementations, after displaying the privacy announcement option, the first UE 105-1 may detect a first user input selecting the privacy announcement option, which may indicate the first user's preference for notifying the call recipient about the privacy status of the call. In some implementations, the first UE 105-1 may generate the in-call privacy announcement alert based on receiving the selection of the privacy announcement option.

As further shown in FIG. 1D, and by reference number 185, the first UE 105-1 may establish a call with the second UE 105-2 and may provide the privacy announcement alert to the second UE 105-2. For example, once the privacy announcement alert is generated, the first UE 105-1 may utilize a telecommunications protocol to initiate a call through the base station 110 and the core network 115 and directed to the second UE 105-2. In some implementations, the first UE 105-1 may embed the privacy announcement alert in the call setup signaling provided to the second UE 105-2. The privacy announcement alert may include information indicating, to the second user of the second UE 105-2, the privacy conditions under which the call is being made.

Additionally, or alternatively, establishing the call and providing the privacy announcement alert may include the first UE 105-1 embedding a privacy flag within a signaling message in the call setup phase between the first UE 105-1 and the second UE 105-2. For example, the first UE 105-1 may insert a specific code or flag within the initial call setup message that instructs the second UE 105-2 to recognize and handle the privacy announcement alert appropriately. Additionally, or alternatively, establishing the call and providing the privacy

announcement alert may include the first UE 105-1 establishing the call with the second UE 105-2 while simultaneously providing the privacy announcement alert to the second UE 105-2. For example, the first UE 105-1 may provide the privacy announcement alert to the second UE 105-2 either through an immediate message or as part of the ongoing call setup, ensuring that the privacy announcement alert is recognized as the call is being established.

As further shown in FIG. 1D, and by reference number 190, the second UE 105-2 may provide the privacy announcement alert to the second user of the second UE 105-2. For example, upon receiving the privacy announcement alert from the first UE 105-1, the second UE 105-2 may display the privacy announcement alert to the second user as a visual notification or may play the privacy announcement alert as an audible alert, informing the second user of the second UE 105-2 of the privacy status of the first UE 105-1. In some implementations, the second UE 105-2 may provide the privacy announcement alert to the second user as a visual alert (e.g., a pop-up message on a screen of the second UE 105-2), an audible alert, an audible and visual alert, a tactile alert (e.g., a distinct vibration pattern), or a combination of these types of alerts to ensure the second user is clearly informed of the privacy announcement alert.

FIG. 1E depicts an example information flow diagram associated with providing privacy alert messages prior to establishing a call. As shown at step 1 of FIG. 1E, the first UE 105-1 may provide an invite message and a profile inquiry tag to the second UE 105-2. For example, the invite message may utilize the session description protocol (SDP) for describing multimedia communication sessions for the purposes of session announcement, session invitation, and parameter negotiation. The invite message may include an SDP offer with an enhanced voice services (EVS) codec for negotiating parameters for a voice call or a multimedia session. The invite message may also include a timer associated with expiration of the invite message. In some implementations, the invite message may be generated based on detecting a connection to a Bluetooth system or an activation of a speakerphone function.

As shown at step 2, the second UE 105-2 may provide, to the first UE 105-1, a session progress response and profile information identifying a privacy status associated with the second UE 105-2. In some implementations, the session progress response may include an SDP answer EVS. As shown at step 3, the first UE 105-1 and the second UE 105-2 may perform a profile communication process. For example, the profile communication process may include the first UE 105-1 and the second UE 105-2 exchanging necessary profile information to ensure appropriate handling of privacy alerts. In some implementations, the profile communication process may include triggering the privacy announcement option or automatically generating the privacy announcement alert.

As shown at step 4, the first UE 105-1 and the second UE 105-2 may establish a real-time protocol (RTP) stream for exchanging profile information. For example, the RTP stream may include a continuous flow of multimedia data (e.g., audio, video, and other types of data) over a network. The first UE 105-1 and the second UE 105-2 may utilize the RTP stream to exchange necessary profile information to ensure appropriate handling of privacy alerts. As shown at step 5, the first UE 105-1 may provide a provisional response acknowledgment (PRACK) to the second UE 105-2. For example, the first UE 105-1 may utilize the PRACK to acknowledge receipt of provisional responses in session initiation protocol (SIP) communications. The provisional responses may indicate that a request is being processed, but final results are not yet available. The PRACK may ensure that the first UE 105-1 and the second UE 105-2 are synchronized when dealing with call setups or media negotiations.

As shown at step 6, the second UE 105-2 may acknowledge receipt of the PRACK with an OK message (e.g., a “200 OK” message). For example, the OK message may include a final response message indicating that a request is complete. As shown at step 7, the second UE 105-2 may provide a SIP update and updated profile information to the first UE 105-1. For example, the SIP update message may include an SDP answer with EVS codec details and updated profile information. In some implementations, the SIP update message may include an embedded privacy flag.

As shown at step 8, the first UE 105-1 may determine that an updated profile is present in the call. For example, the first UE 105-1 may detect a connection with a Bluetooth system or an activation of a speakerphone function, and may determine an updated profile for the call based on detecting the connection with the Bluetooth system or the activation of the speakerphone function. The updated profile may indicate that the call should include a privacy announcement alert. As shown at step 9, the first UE 105-1 and the second UE 105-2 may establish an RTP stream for exchanging profile information and early media. For example, the first UE 105-1 and the second UE 105-2 may utilize the RTP stream to exchange the updated profile information indicating that the call should include a privacy announcement alert.

As shown at step 10, the first UE 105-1 may provide a second PRACK to the second UE 105-2. For example, the first UE 105-1 may utilize the second PRACK to acknowledge receipt of provisional responses in SIP communications. The provisional responses may indicate that a request is being processed, but final results are not yet available. As shown at step 11, the second UE 105-2 may acknowledge receipt of the second PRACK with a second OK message (e.g., a “200 OK” message). For example, the second OK message may include a final response message indicating that a request is complete. As shown at step 12, the second UE 105-2 may provide a ringing message (e.g., a “180 ringing” message) to the first UE 105-1. For example, the ringing message may include a provisional response indicating that call setup is in progress.

As shown at step 13, the first UE 105-1 may provide a third PRACK to the second UE 105-2. For example, the first UE 105-1 may utilize the third PRACK to acknowledge receipt of provisional responses in SIP communications. The provisional responses may indicate that a request is being processed, but final results are not yet available. As shown at step 14, the second UE 105-2 may acknowledge receipt of the third PRACK with a third OK message (e.g., a “200 OK” message). For example, the third OK message may include a final response message indicating that a request is complete. As shown at step 15, the first UE 105-1 may acknowledge receipt of the third OK message.

As shown at step 16, the first UE 105-1 and the second UE 105-2 may establish an RTP stream for a voice call. For example, the first UE 105-1 and the second UE 105-2 may utilize the RTP stream to conduct a voice call. As shown at step 17, the first UE 105-1 and the second UE 105-2 may conduct the voice call with the privacy announcement alert indicating that the voice call is to remain private.

FIG. 1F depicts an example information flow diagram associated with providing privacy alert messages after establishing a call. For example, the invite message may utilize the SDP for describing multimedia communication sessions for the purposes of session announcement, session invitation, and parameter negotiation. The invite message may include an SDP offer with an EVS codec for negotiating parameters for a voice call or a multimedia session. The invite message may also include a timer associated with expiration of the invite message. In some implementations, the invite message may be generated based on detecting a connection to a Bluetooth system or an activation of a speakerphone function.

As shown at step 2, the second UE 105-2 may provide, to the first UE 105-1, a session progress response and profile information identifying a privacy status associated with the second UE 105-2. In some implementations, the session progress response may include an SDP answer EVS. As shown at step 3, the first UE 105-1 and the second UE 105-2 may conduct a voice call. For example, the first UE 105-1 and the second UE 105-2 may conduct the voice call based on the session progress response.

As shown at step 4, the first UE 105-1 and the second UE 105-2 may establish an RTP stream for exchanging profile information. For example, the RTP stream may include a continuous flow of multimedia data (e.g., audio, video, and other types of data) over a network. The first UE 105-1 and the second UE 105-2 may utilize the RTP stream to exchange necessary profile information to ensure appropriate handling of privacy alerts. As shown at step 5, the second UE 105-2 may provide a ringing message (e.g., a “180 ringing” message) to the first UE 105-1. For example, the ringing message may include a provisional response indicating that call setup is in progress.

As shown at step 6, the first UE 105-1 may provide a PRACK to the second UE 105-2. For example, the first UE 105-1 may utilize the PRACK to acknowledge receipt of provisional responses in SIP communications. The provisional responses may indicate that a request is being processed, but final results are not yet available. The PRACK may ensure that first UE 105-1 and the second UE 105-2 are synchronized when dealing with call setups or media negotiations. As shown at step 7, the second UE 105-2 may acknowledge receipt of the PRACK with an OK message (e.g., a “200 OK” message). For example, the OK message may include a final response message indicating that a request is complete.

As shown at step 8, the first UE 105-1 and the second UE 105-2 may establish an RTP stream for the voice call. For example, the first UE 105-1 and the second UE 105-2 may

utilize the RTP stream to conduct a voice call. As shown at step 9, the first UE 105-1 and the second UE 105-2 may perform a profile communication process. For example, the profile communication process may include the first UE 105-1 and the second UE 105-2 exchanging necessary profile information to ensure appropriate handling of privacy alerts. In some implementations, the profile communication process may include triggering the privacy announcement option or automatically generating the privacy announcement alert.

As shown at step 10, the second UE 105-2 may provide a SIP reinvite message and updated profile information to the first UE 105-1. For example, the SIP reinvite message may include an SDP offer with EVS codec details and updated profile information. In some implementations, the SIP reinvite message may include an embedded privacy flag. As shown at step 11, the second UE 105-2 may acknowledge receipt of the SIP reinvite message with an OK message (e.g., a “200 OK” message). For example, the OK message may include a final response message indicating that a request is complete.

As shown at step 12, the first UE 105-2 may determine that updated profile information is present in the call. For example, the first UE 105-1 may detect connection with a Bluetooth system or activation of speakerphone function, and may determine an updated profile for the call based on detecting the connection with the Bluetooth system or the activation of the speakerphone function. The updated profile may indicate that the call should include a privacy announcement alert. As shown at step 13, the first UE 105-1 and the second UE 105-2 may establish an RTP stream for exchanging profile information and media. For example, the first UE 105-1 and the second UE 105-2 may utilize the RTP stream to exchange the updated profile information indicating that the call should include a privacy announcement alert.

As shown at step 14, the second UE 105-2 may provide a second SIP reinvite

message to the first UE 105-1. For example, the SIP reinvite message may include an SDP offer with EVS codec details. As shown at step 15, the first UE 105-1 may acknowledge receipt of the second SIP reinvite message with a second OK message (e.g., a “200 OK” message). For example, the OK message may include a final response message indicating that a request is complete. As shown at step 16, the first UE 105-1 and the second UE 105-2 may establish an RTP stream for a voice call. For example, the first UE 105-1 and the second UE 105-2 may utilize the RTP stream to conduct a voice call. The first UE 105-1 and the second UE 105-2 may conduct the voice call with the privacy announcement alert indicating that the voice call is to remain private.

In this way, a UE 105 may provide in-call privacy alert messages. For example, the first UE 105-1 may utilize existing telecommunications protocols to relay privacy notifications to the second UE 105-2, thereby minimizing a likelihood of sensitive information disclosure. The first UE 105-1 may embed privacy flags directly into call setup signaling messages, which may enhance technical interoperability between different devices. The first UE 105-1 may provide security for a call with the second UE 105-2 by preemptively managing privacy considerations through automated means. The first UE 105-1 may ensure resource-efficient management of privacy-related features by building upon existing communication capabilities of the first UE 105-1, resulting in enhanced operational efficiency and optimized utilization of processing and memory resources of the first UE 105-1. Thus, the first UE 105-1 may conserve computing resources, networking resources, and/or other resources that would have otherwise been consumed by failing to provide an effective means for a user to communicate a status of a call audio output to another party involved in the call, inadvertently sharing sensitive or private information via call audio output, handling privacy breaches caused by inadvertently sharing

sensitive or private information via call audio output, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

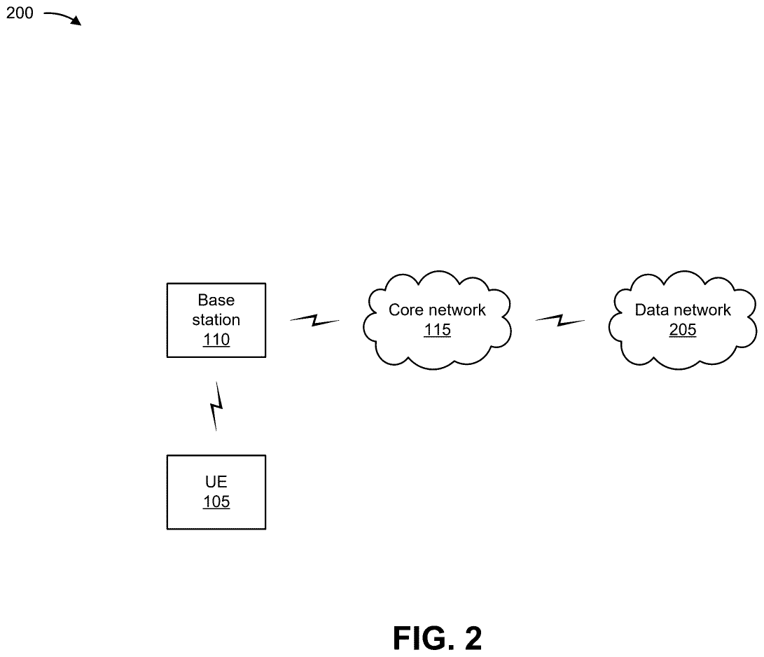

FIG. 2 is a diagram of an example environment 200 in which systems and/or methods described herein may be implemented. As shown in FIG. 2, the example environment 200 may include the UE 105, the base station 110, the core network 115, and a data network 205. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 110 may transfer traffic between the UE 105 (e.g., using a cellular RAT), one or more base stations (e.g., using a wireless interface or a backhaul interface, such as a wired backhaul interface), and/or the core network 115. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

In some implementations, the core network 115 may include an example functional architecture in which systems and/or methods described herein may be implemented. For example, the core network 115 may include an example architecture of a fifth generation (5G) next generation (NG) core network included in a 5G wireless telecommunications system. While

the example architecture of the core network 115 shown in FIG. 2 may be an example of a service-based architecture, in some implementations, the core network 115 may be implemented as a reference-point architecture and/or a 4G core network, among other examples.

The data network 205 includes one or more wired and/or wireless data networks. For example, the data network 205 may include an Internet Protocol (IP) Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

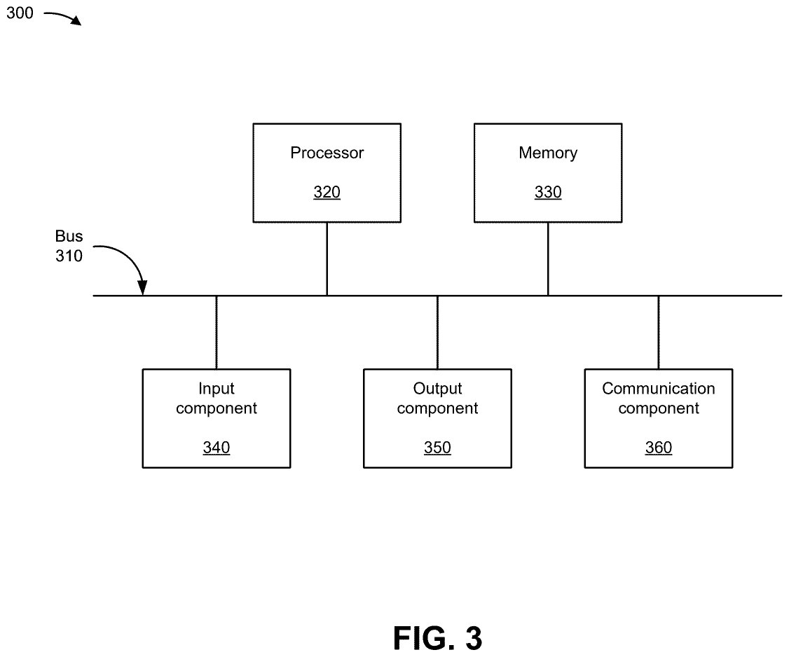

FIG. 3 is a diagram of example components of a device 300, which may correspond to the UE 105 and/or the base station 110. In some implementations, the UE 105 and/or the base station 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning

system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

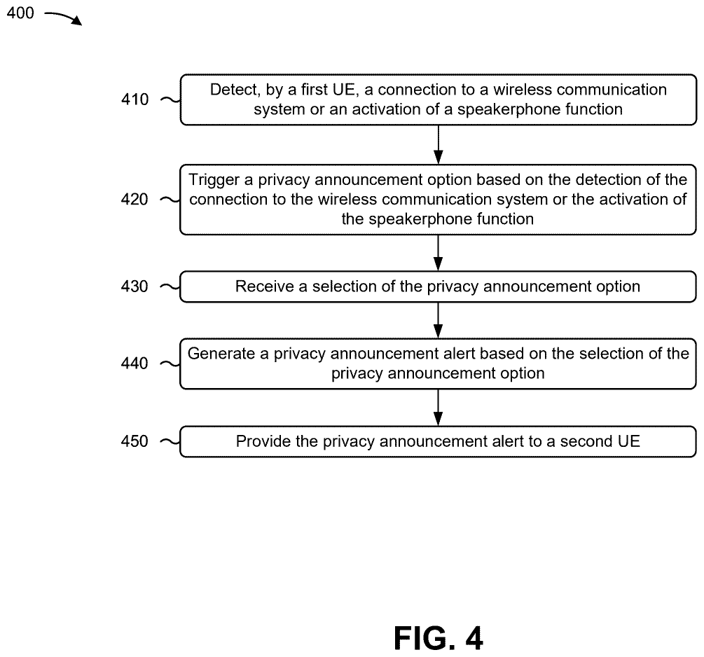

FIG. 4 is a flowchart of an example process 400 for providing in-call privacy alert messages. In some implementations, one or more process blocks of FIG. 4 may be performed by a device, such as a UE (e.g., the UE 105). In some implementations, one or more process blocks of FIG. 4 may be performed by another device or a group of devices separate from or including the device. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include detecting a connection to a wireless communication system or an activation of a speakerphone function (block 410). For example, the first UE may detect a connection to a wireless communication system or an activation of a speakerphone function, as described above. In some implementations, detecting the connection to the wireless communication system includes determining that the first UE is paired with a Bluetooth profile. In some implementations, detecting the activation of the speakerphone function includes monitoring an activation status of the speakerphone function within an operating system of the first UE. In some implementations, the speakerphone function is provided by the first UE or by a speaker that is separate from the first UE.

As further shown in FIG. 4, process 400 may include triggering a privacy announcement option based on the detection of the connection to the wireless communication system or the activation of the speakerphone function (block 420). For example, the first UE may trigger a privacy announcement option based on the detection of the connection to the wireless communication system or the activation of the speakerphone function, as described

above. In some implementations, triggering the privacy announcement option includes displaying one or more predefined message options for the privacy announcement alert.

As further shown in FIG. 4, process 400 may include receiving a selection of the privacy announcement option (block 430). For example, the first UE may receive a selection of the privacy announcement option, as described above. In some implementations, receiving the selection of the privacy announcement option includes providing a user interface element associated with the privacy announcement option, detecting a touch input of the user interface element, and receiving the selection of the privacy announcement option based on detecting the touch input of the user interface element.

As further shown in FIG. 4, process 400 may include generating a privacy announcement alert based on the selection of the privacy announcement option (block 440). For example, the first UE may generate a privacy announcement alert based on the selection of the privacy announcement option, as described above. In some implementations, the privacy announcement alert includes one or more of an indication that a user of the first UE is in a vehicle with other passengers, an indication that the user of the first UE is using a speakerphone, or a custom message selected or provided by the user of the first UE. In some implementations, the privacy announcement alert is one of a visual alert, an audible alert, a tactile alert, or a visual and audible alert.

As further shown in FIG. 4, process 400 may include providing the privacy announcement alert to a second UE to cause the second UE to provide the privacy announcement alert to a user of the second UE (block 450). For example, the first UE may provide the privacy announcement alert to a second UE to cause the second UE to provide the privacy announcement alert to a user of the second UE, as described above. In some implementations, providing the

privacy announcement alert to the second UE includes embedding a privacy flag within a signaling message in a call setup phase between the first UE and the second UE. In some implementations, the second UE displays the privacy announcement alert as a visual alert or plays the privacy announcement alert as an audible alert.

In some implementations, process 400 includes automatically enabling the privacy announcement option based on predefined user settings associated with the connection to the wireless communication system or the activation of the speakerphone function. In some implementations, process 400 includes establishing a call with the second UE prior to providing the privacy announcement alert to the second UE. In some implementations, process 400 includes establishing a call with the second UE while simultaneously providing the privacy announcement alert to the second UE.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to

include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
detecting, by a first user equipment, a connection to a wireless communication system or an activation of a speakerphone function;
triggering, by the first user equipment, a privacy announcement option based on the detection of the connection to the wireless communication system or the activation of the speakerphone function;
receiving, by the first user equipment, a selection of the privacy announcement option;
generating, by the first user equipment, a privacy announcement alert based on the selection of the privacy announcement option; and
providing, by the first user equipment, the privacy announcement alert to a second user equipment.

2. The method of claim 1, wherein detecting the connection to the wireless communication system comprises:
determining that the first user equipment is paired with a Bluetooth profile.

3. The method of claim 1, wherein detecting the activation of the speakerphone function comprises:
monitoring an activation status of the speakerphone function within an operating system of the first user equipment.

4. The method of claim 1, wherein triggering the privacy announcement option comprises:
displaying one or more predefined message options for the privacy announcement alert.

5. The method of claim 1, further comprising:
automatically enabling the privacy announcement option based on predefined user settings associated with the connection to the wireless communication system or the activation of the speakerphone function.

6. The method of claim 1, wherein providing the privacy announcement alert to the second user equipment comprises:
embedding a privacy flag within a signaling message in a call setup phase between the first user equipment and the second user equipment.

7. The method of claim 1, wherein the second user equipment displays the privacy announcement alert as a visual alert or plays the privacy announcement alert as an audible alert.

8. A first user equipment, comprising:
one or more processors configured to:
detect a connection to a wireless communication system or an activation of a speakerphone function;
trigger a privacy announcement option based on the detection of the connection to the wireless communication system or the activation of the speakerphone function;
receive a selection of the privacy announcement option;
generate a privacy announcement alert based on the selection of the privacy announcement option; and
provide the privacy announcement alert to a second user equipment to cause the second user equipment to display the privacy announcement alert as a visual alert or to play the privacy announcement alert as an audible alert.

9. The first user equipment of claim 8, wherein the privacy announcement alert includes one or more of:
an indication that a user of the first user equipment is in a vehicle with other passengers,
an indication that the user of the first user equipment is using a speakerphone, or
a custom message selected or provided by the user of the first user equipment.

10. The first user equipment of claim 8, wherein the one or more processors are further configured to:
establish a call with the second user equipment prior to providing the privacy announcement alert to the second user equipment.

11. The first user equipment of claim 8, wherein the one or more processors are further configured to:
establish a call with the second user equipment while simultaneously providing the privacy announcement alert to the second user equipment.

12. The first user equipment of claim 8, wherein the privacy announcement alert is one of a visual alert, an audible alert, a tactile alert, or a visual and audible alert.

13. The first user equipment of claim 8, wherein the one or more processors, to receive the selection of the privacy announcement option, are configured to:
provide a user interface element associated with the privacy announcement option;
detect a touch input of the user interface element; and
receive the selection of the privacy announcement option based on detecting the touch input of the user interface element.

14. The first user equipment of claim 8, wherein the speakerphone function is provided by the first user equipment or by a speaker that is separate from the first user equipment.

15. A non-transitory computer-readable medium storing a set of instructions, the set of instructions comprising:
one or more instructions that, when executed by one or more processors of a first user equipment, cause the first user equipment to:
detect a connection to a wireless communication system or an activation of a speakerphone function;
trigger a privacy announcement option based on the detection of the connection to the wireless communication system or the activation of the speakerphone function;
receive a selection of the privacy announcement option;
generate a privacy announcement alert based on the selection of the privacy announcement option,
wherein the privacy announcement alert is one of a visual alert, an audible alert, a tactile alert, or a visual and audible alert; and
provide the privacy announcement alert to a second user equipment to cause the second user equipment to provide the privacy announcement alert to a user of the second user equipment.

16. The non-transitory computer-readable medium of claim 15, wherein the one or more instructions, that cause the first user equipment to trigger the privacy announcement option, cause the first user equipment to:
display one or more predefined message options for the privacy announcement alert.

17. The non-transitory computer-readable medium of claim 15, wherein the one or more instructions further cause the first user equipment to:
automatically enable the privacy announcement option based on predefined user settings associated with the connection to the wireless communication system or the activation of the speakerphone function.

18. The non-transitory computer-readable medium of claim 15, wherein the one or more instructions, that cause the first user equipment to provide the privacy announcement alert to the second user equipment, cause the first user equipment to:
embed a privacy flag within a signaling message in a call setup phase between the first user equipment and the second user equipment.

19. The non-transitory computer-readable medium of claim 15, wherein the one or more instructions further cause the first user equipment to one of:
establish a call with the second user equipment prior to providing the privacy announcement alert to the second user equipment; or
establish a call with the second user equipment while simultaneously providing the privacy announcement alert to the second user equipment.

20. The non-transitory computer-readable medium of claim 15, wherein the one or more instructions, that cause the first user equipment to receive the selection of the privacy announcement option, cause the first user equipment to:
provide a user interface element associated with the privacy announcement option;
detect a touch input of the user interface element; and
receive the selection of the privacy announcement option based on detecting the touch input of the user interface element.
